(19) United States
(12) Patent Application Publication
(10) Pub. No.: US 2014/0305594 A1
(43) Pub. Date: Oct. 16, 2014

(54) LABELING MACHINE WITH SWITCH CABINET

(71) Applicant: KRONES AG, Neutraubling (DE)

(72) Inventors: Dieter Hafner, Regensburg (DE); Andreas Bergers, Pfatter (DE)

(73) Assignee: KRONES AG, Neutraubling (DE)

(21) Appl. No.: 14/171,895

(22) Filed: Feb. 4, 2014

(30) Foreign Application Priority Data
Apr. 15, 2013 (DE) 102013206663.5

(51) Int. Cl. B65C 9/00; B65C 9/02

(52) U.S. Cl. CPC B65C 9/00; B65C 9/02
USPC 156/567; 156/556

(57) ABSTRACT

Labeling machine, at which at least one or more labeling aggregates can be arranged at different places, having one or more conveyors for feeding and removing containers, and a switch cabinet, wherein the at least one labeling aggregate can be arranged on an operating side of the conveyor, wherein the switch cabinet is arranged on this operating side, wherein the switch cabinet comprises at least one switching component. The labeling machine includes a pull-out element on which the at least one switching component is arranged.

### CROSS-REFERENCE TO RELATED APPLICATION

The present application claims priority to German Application No.10 2013 206 663.5, filed Apr. 15, 2013. The priority application, DE 10 2013 206 663.5, is hereby incorporated by reference.

### FIELD OF THE DISCLOSURE

The present disclosure relates to an apparatus, in particular to a labeling machine with a switch cabinet associated therewith.

### BACKGROUND

Labeling machines are known from the prior art. Switch cabinets, for example those comprising switching devices, are known as well.

The DE 10 2006 054 637 B4 document shows, for example, a switch cabinet having a case and a door. Switching device units are arranged in this case. This switch cabinet comprises a pivoting bolt which cooperates with a locking and unlocking mechanism and a switch-on blocking element so that the door cannot be opened in the activated state of the switching device and the switching device cannot be activated if the door is open.

In addition, apparatus cabinets, e.g. server cabinets, are described in DE 199 62 659 A1, where an asymmetrical arrangement of the installation space and the arranged apparatus, e.g. servers, permits a clearance for the cable routing and cable bearers.

### OBJECT

The present disclosure is based on the object to provide an arrangement of switch cabinets for labeling machines with minimum space requirements, which is easily accessible by the operating staff.

### SUMMARY

The labeling machine, at which one or more labeling aggregates can be arranged at different places, includes one or more conveyors for feeding and removing containers, and a switch cabinet, wherein the at least one labeling aggregate can be arranged on an operating side of the conveyor and also the switch cabinet is arranged on this operating as side. The switch cabinet includes at least one switching component, and a pull-out element on which the at least one switching component is arranged. Thus, a switch cabinet is provided which is accessible to the operating staff on the operating side, and therefore without crossing the conveyor, and at the same time ensures a space-saving arrangement of the switch cabinet because, for example, swing doors can be waived.

In addition, the pull-out element may be mounted to be pivotable, preferably in the fully pulled out state. If the pull-out element is mounted pivotably it is possible for an operator to view and operate the pull-out element, and in particular the switching component fixed thereto, preferably from two sides.

In another embodiment the pull-out element is adapted such that it can be pulled out parallel to the conveyor adjacent to the pull-out element. Thus, even more space is saved.

Furthermore, the pull-out element may be adapted to be rotatable about an axis defined by the pull-out element and/or a connection with the switch cabinet. This may be provided in addition to the pivoting so that not only two sides, but for example also the bottom side of the pull-out element and the switching component may be viewed. It may also be provided as an alternative to the pivoting, however, so that an additional saving of space is achieved by the rotation as the whole pull-out element and the switching component thus become accessible without pivoting.

Also, the pull-out element may be adapted to be removable from the cabinet. Thus, the exchange of switching components is facilitated significantly, and it is not necessary to exchange or disassemble the whole switch cabinet.

In another embodiment the switch cabinet is either fixed permanently to the labeling machine, or connected to the labeling machine by detachable connections. If the switch cabinet is fixedly mounted on the labeling machine in particular an easier transport of the labeling machine as a whole is possible. Providing detachable connections facilitates the exchange of the switch cabinet.

Moreover, the labeling machine may comprise a carrousel.

In this case, the carrousel and the at least one conveyor may enclose an angular range, wherein the switch cabinet is arranged in this angular range. Thus, too, space is saved because this angular range would otherwise remain unused.

In another embodiment the pull-out element is pivotable about a vertical axle.

In addition, the switch cabinet may include switch cabinet walls which are suited to protect the interior of the switch cabinet at least partially defined by them against environmental influences. In this interior the pull-out element is in a retracted state. Thus, if the element is retracted, for example, the interior and hence the at least one switching component are protected against dust, cleansing liquids or adhesives.

In another embodiment at least one of the conveyors is arranged to be either directly adjacent to the switch cabinet, or a partition wall is arranged between the conveyor and the switch cabinet.

### BRIEF DESCRIPTION OF THE SEVERAL VIEWS OF THE DRAWINGS

FIG. 1 is a schematic view of a labeling machine with a switch cabinet according to one embodiment;

FIG. 2 is a schematic view of a switch cabinet according to one embodiment;

FIG. 3 is a top view of the switch cabinet illustrated in FIG. 2;

FIG. 4 is a schematic view of a switch cabinet according to another embodiment;

FIG. 5 is an end view of the embodiment of the switch cabinet illustrated in FIG. 4.

### DETAILED DESCRIPTION

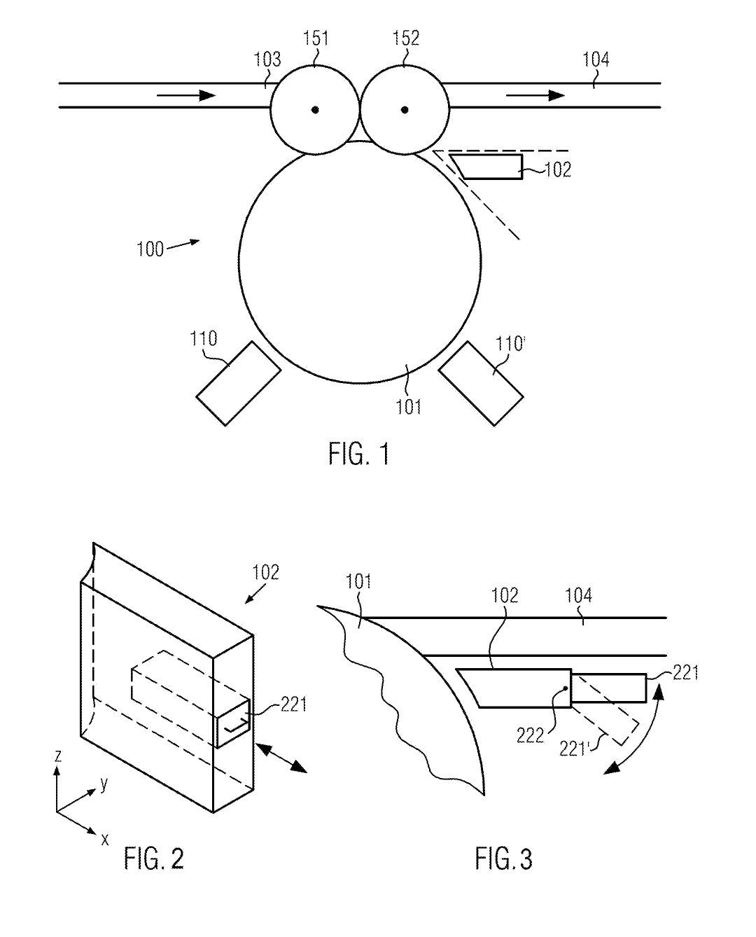

FIG. 1 shows a labeling machine 100 according to the present disclosure. This labeling machine 100 comprises, for example, a carrousel 101, but may also be designed differently. The labeling machine 100 is preferably suited to label containers, e.g. bottles. For this purpose, it comprises labeling aggregates 110 and 110′ which are arrangeable on its periphery. Depending on the intended labeling there may be provided more or fewer labeling aggregates, which are distributed at specific positions on the periphery of the carrousel 101. Moreover, a conveyor 103 is provided, which is capable of conveying containers to the labeling machine 100. The conveyor 103 may be, for example, a linear conveyor in the form of conveyor belts or the like. A second conveyor 104 conveys the labeled containers out of the labeling machine 100. Instead of two separate conveyors 103 and 104 a one-piece conveyor for feeding and removing containers may be provided. For reversing, respectively feeding and removing, containers reversing elements 151 and 152 may be provided, e.g. reversing sprockets.

It should be noted that in addition to the use of the invention in the field of labeling machines as described below the invention may also be employed for other container handling machines, in particular printing machines, filling machines, blow-molding machines or similar machines, provided they are constructed comparably, viz. preferably comprise a carrousel and corresponding conveyors for feeding and removing containers.

The controlling of the whole labeling machine 100 requires switching components. As it may be necessary, in particular in the event of a malfunction of the labeling machine, that these switching components are accessible to the operating staff it is expedient to arrange a corresponding switch cabinet 102 on the side of the conveyors 103 and 104 that points to the labeling aggregates 110 and 110′. This side will be referred to as operating side below. Providing a switch cabinet in this position, which is shown, for example, in FIG. 1, allows an operation of the switching components on the operating side as closely as possible to the labeling aggregates 110 and 110′, so that time may be saved, for example. In order to save space, in particular if a carrousel labeling machine is used, the switch cabinet 102 is arranged in the angular range which is enclosed, for example, by the conveyor 104 and the carrousel 101, as is shown by dashed lines in FIG. 1, where no labeling aggregates 110 or 110′ would be arranged on the operating side anyhow owing to a lack of space. Therefore, this space may be used expediently, for example, for such a switch cabinet 102. The dimensions of the switch cabinet and the shape thereof are adapted such that no space is required for positioning labeling aggregates.

FIGS. 2 and 3 illustrate a possible embodiment of a switch cabinet 102. It can be seen in FIG. 2 that the switch cabinet 102 is preferably expanded in the X- and Z-directions, meaning that it has the greatest dimensions in these directions, while it is kept as narrow as possible in the Y-direction. Thus, the space available between the labeling machine and the conveyor is used as effectively as possible, and the switch cabinet only projects into the production space to a small extent. The design of the switch cabinet 102 is, therefore, approximately comparable with that of an apothecary cabinet, and the switch cabinet 102 comprises in particular a pull-out element 221 with switching components. As is demonstrated by means of the arrows the element 221 can be pulled out of the switch cabinet 102 in the X-direction. By this, space-wasting doors, in particular swing doors, are avoided. Useful dimensions in the Y-direction are in particular values smaller than 50 cm, preferably smaller than 30 cm. The dimensions in the X- and Z-directions may, in principle, be optional, although dimensions easy to handle are preferred, and which furthermore do not project into the region next to the labeling machine to a great extent (in particular if the pull-out element is pulled out entirely). Hence, dimensions of up to 2 m, preferably up to 1.80 m, are suitable in the Z-direction, which permit an operator to have access to any of the pull-out elements. In the X-directions dimensions of the switch cabinet of up to 1 m are preferred, so that the dimensions of the overall assembly, with a fully pulled out pull-out element, do not exceed 2 m.

As was mentioned above, the switch cabinet according to the invention described herein may also be employed in other machines for handling containers, e.g. printing machines, fillers and blow-molding machines.

Preferably, the pull-out elements 221 have handles or other means for pulling them out. It may also be provided that the pulling out of a pull-out element 221 is accomplished by means of a motor. Here, in particular those operating modes stand out that subject the pull-out elements 221, and thus the switching components, to as few vibrations as possible. A combination of motors and handles may also be advantageous.

As can be seen in FIG. 3, illustrating a top view from the Z-direction, the pull-out element 221 and the switch cabinet 102 may preferably be adapted such that it is arranged parallel to the conveyor 104 and the pull-out element 221 can also be pulled out of the switch cabinet parallel to this conveyor. If the switch cabinet 102 is arranged very closely to the conveyor 104 an operator would have access only to the one side of the pull-out element on which at least one of the switching components is arranged. Therefore, the pull-out element 221 is preferably mounted to be pivotable about an axle 222, which is arranged in the Z-direction, allowing it to be pivoted into the dashed position 221. In this position an operator is able to view and operate also the other side of the element 221, respectively switching component.

Basically, the switch cabinet 102 may also comprise more than one pull-out element 221, wherein not only one, but also a plurality of switching components may be arranged on each of the elements. The individual pull-out element illustrated here is, therefore, illustrated individually only for reasons of simplification.

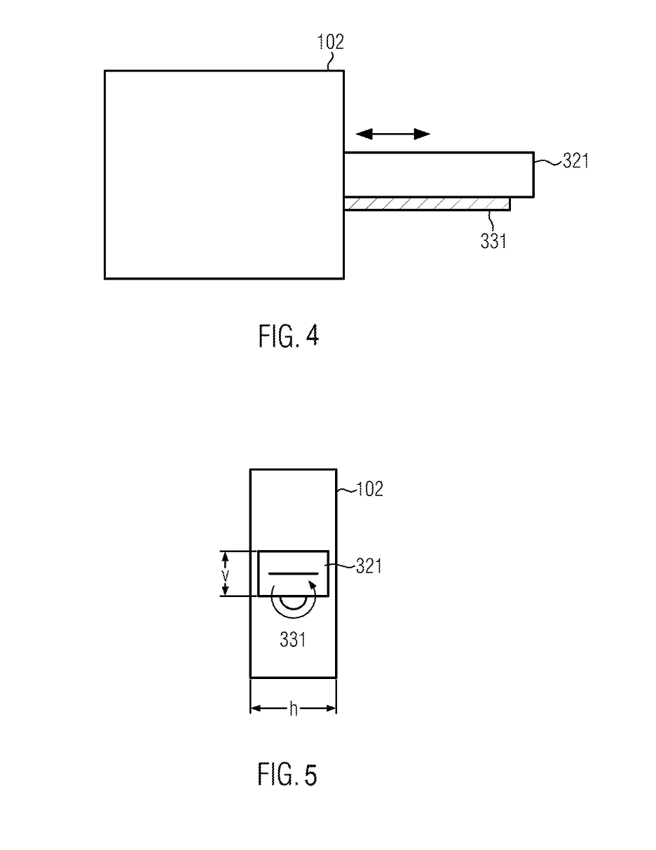

FIGS. 4 and 5 illustrate an alternative embodiment of the switch cabinet 102 and, in particular, of the pull-out element 321. According to FIG. 4, analogous to FIG. 2, the pull-out element 321 is mounted such that it can be pulled out from the switch cabinet 102 in the indicated arrow direction. However, in this embodiment it is preferably not connected to the switch cabinet 102 using fixed connections, but by means of the axle 331 which is fixedly connected to the pull-out element 321 on the one side and, on the other hand, to a non-illustrated bearing in the switch cabinet 102 on the other side.

FIG. 5 illustrates the functional principle of this axle 331. This axle 331 is fixed in a corresponding bearing in the switch cabinet 102 to allow a rotation of the pull-out element 321 about the axle 331. Thus, it becomes possible to waive the pivoting capacity of the pull-out element, resulting in an additional saving of space. The rotational capability of the pull-out element 321 about the axle 331 guarantees that a viewing of the pull-out element and the switching components provided therein can, in fact, take place from all directions with a minimum of space requirements. Preferably, the vertical expansion v of the pull-out element shown in FIG. 5 is smaller than half of the horizontal expansion h of the switch cabinet. Thus, it is obtained that even if the pull-out element 321 rotates about the axle 331 the former will never project beyond the boundary of the switch cabinet 102, by which it is obtained that, for example, the conveyor 104 can be directly passed past the switch cabinet 102, as is shown in FIG. 1. In this case, too, a motion of the pull-out element 321 by means of a motor may be expedient, in particular so as to control the rotation about the axle 331 in a well-directed manner. It may furthermore be advantageous to provide stops, respectively catches, along the path of rotation so that the pull-out element may be locked in place in specific angular positions in order for maintenance work to be carried out. A rough graduation, e.g. in 10° steps, may be enough, although rougher or finer graduations are possible, too.

It is basically advantageous to realize an attachment of the exchangeable elements in the switch cabinet by means of detachable connections to allow an exchange or removal of the pull-out elements. In addition, the configuration of the switch cabinet 102 with pull-out elements allows the positioning of the switch cabinet 102, for example, inside a machine guard (transparent plexiglass walls or the like), whereby recesses may be provided allowing to pull the pull-out elements out of the switch cabinet. Thus, the switch cabinet is protected against undesired environmental influences, such as humidity. Additionally, the switch cabinet may include protective walls which separate the so formed interior of the switch cabinet from the exterior and protect it against environmental influences. In this regard it is particularly advantageous if the pull-out elements are framed by rubber gaskets which, if the pull-out elements are located in the switch cabinet 102, seal the same.

In particular the embodiment of the switch cabinet according to FIGS. 4 and 5 allows a maximum space-saving, so that an arrangement of the switch cabinet in the close proximity of the corresponding conveyor is possible. It is important to note that, although the switch cabinet has here been illustrated to be adjacent to the conveyor 104 (e.g. FIGS. 1, 2, and 3), it is also possible to position it, for example, analogously on the carrousel in FIG. 1, in the proximity of the first conveyor 103.

1. A labeling machine, at which at least one or more labeling aggregates can be arranged at different places, comprising one or more conveyors for feeding and removing containers, and a switch cabinet;
wherein the at least one labeling aggregate can be arranged on an operating side of the conveyor;
wherein the switch cabinet is arranged on the operating side,
wherein the switch cabinet comprises at least one switching component, and comprises a pull-out element on which the at least one switching component is arranged.

2. A labeling machine according to claim 1, the pull-out element being mounted to be pivotable.

3. A labeling machine according to claim 1, the pull-out element adapted such that it can be pulled out parallel to the conveyor adjacent to the pull-out element.

4. A labeling machine according to claim 1, the pull-out element adapted to be rotatable about an axis defined by at least one of the pull-out element and a connection with the switch cabinet.

5. A labeling machine according to claim 1, the pull-out element adapted to be removable from the cabinet.

6. A labeling machine according to claim 1, the switch cabinet is fixed permanently to the labeling machine.

7. A labeling machine according to claim 1, the labeling machine comprising a carrousel.

8. A labeling machine according to claim 7, the carrousel and the conveyor enclosing an angular range and the switch cabinet arranged in this angular range.

9. A labeling machine according to claim 2, the pull-out element being pivotable about a vertical axle.

10. A labeling machine according to claim 1, the switch cabinet comprising switch cabinet walls which are suited to protect an a interior of the switch cabinet at least partially defined by the switch cabinet walls against environmental influences.

11. A labeling machine according to claim 1, at least one of the one or more conveyors being arranged to be directly adjacent to the switch cabinet.

12. The labeling machine according to claim 2, the pull-out element being pivotable in a fully pulled out state.

13. The labeling machine according to claim 1, the switch cabinet connected to the labeling machine by one or more detachable connections.

14. The labeling machine according to claim 1, a partition wall being arranged between at least one of the one or more conveyors and the switch cabinet.
